(19) United States
(12) Patent Application Publication
(10) Pub. No.: US 2014/0169546 A1
(43) Pub. Date: Jun. 19, 2014

(54) COMMUNICATION DEVICE AND METHOD FOR PERFORMING CALL TRANSFER FUNCTION

(71) Applicant: HON HAI PRECISION INDUSTRY CO., LTD., New Taipei (TW)

(72) Inventor: HONG-SHENG CHEN, New Taipei (TW)

(73) Assignee: HON HAI PRECISION INDUSTRY CO., LTD., New Taipei (TW)

(21) Appl. No.: 14/098,548

(22) Filed: Dec. 6, 2013

(30) Foreign Application Priority Data
Dec. 19, 2012 (TW) 101148299

(51) Int. Cl. H04M 3/54

(52) U.S. Cl. CPC H04M 3/54
USPC 379/212.01

(57) ABSTRACT

A method for transferring a call from a callee device to a call-transfer device. The method includes providing transfer information. The transfer information records at least one ID of the callee device, an information of at least one call-transfer device which is allowed to receive the call transferred from the callee device. Then, responding to a call request from a caller device and selecting at least one call-transfer device according to the transfer information. And transferring the call to the selected call-transfer device.

### BACKGROUND

1. Technical Field

The present disclosure relates to communication devices, and particularly to a communication device capable of performing call transfer function and a method applied in the communication device.

2. Description of Related Art

Call transfer functions are provided for communication devices, to enable a user to redirect an incoming call to another communication device such as a fixed phone. However, the users may miss knowing about important incoming calls when she/he moves away from the fixed phone. Therefore, the currently used method and the current communication device are not reliable.

Therefore, there is room for improvement in the art.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a perspective view of a communication system in accordance with an embodiment.

FIG. 2 is a block diagram of a communication device in accordance with an embodiment.

FIG. 3 is a table for showing transfer information being built in accordance with an embodiment.

FIG. 4 is a flowchart of a method for transferring a call, in accordance with an embodiment.

### DETAILED DESCRIPTION

Embodiments of the present disclosure are described in detail, with reference to the accompanying drawings.

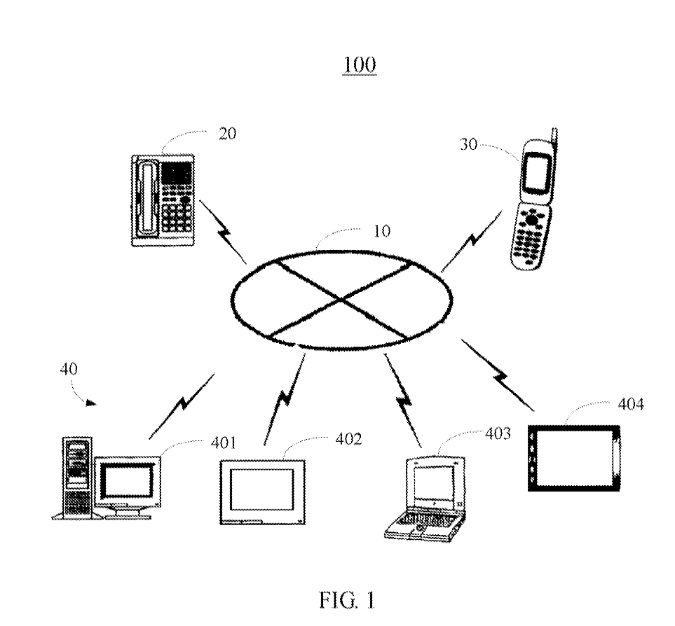

FIG. 1 shows an embodiment of a communication system 100. The communication system 100 includes a communication network 10 and a number of communication devices communicating with each other via the communication network 10, hereinafter, a caller device 20, a callee device 30, and a number of call-transfer devices 40. The term “caller” herein is used to indicate a user who initiates a telephone call, whereas “callee” indicates an intended recipient of the telephone call. The caller device 20, the callee device 30, and the call-transfer devices 40 (including 401, 402, 403 and 404) may be any type of electronic devices capable of telecommunicating with communication network 10, such as a fixed phone, a computer or a mobile phone. Each device 20, 30, 40 can initiate a telephone call, and can also act as an intended recipient of the telephone call. Each device 20, 30, 40 includes a microphone, a speaker, a display (not shown).

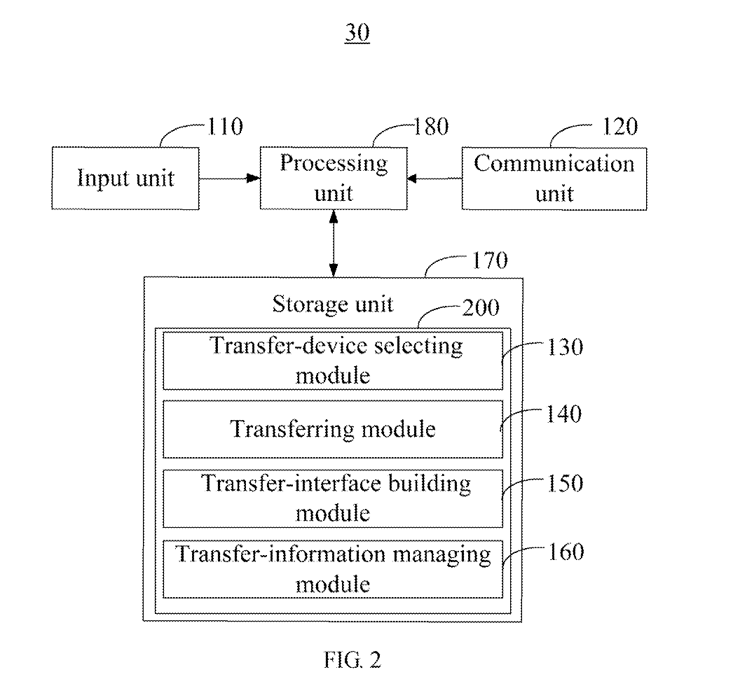

FIG. 2 shows that the callee device 30 includes an input unit 110, a communication unit 120, a storage unit 170, and a processor unit 180.

The input unit 110 responds to manual input to generate various control commands. The input unit 110 may be buttons of the callee device 30, or a remote control capable of remotely controlling the callee device 30.

The communication unit 120 receives a call request from the caller device 20. The call request includes at least an ID (Identify) of the caller device 20. When the callee device 30 initiates a telephone call, namely, the callee devices 30 functions as a caller, the communication 120 transmits a call request including an ID thereof to the intended callee device.

The storage unit 170 stores a transfer system 200 including a number of modules. In the embodiment, the transfer system 200 includes a transfer-device selecting module 130, a transferring module 140, a transfer-interface building module 150, and a transfer-information managing module 160. The processing unit 180 executes the number of modules of the transfer system 200 to perform functions of the device 100. The storage unit 170 further stores a transfer information. The transfer information records at least one ID of a callee device 30, an information of each call-transfer device 40 which is allowed to receive the telephone call transferred from the callee device 30. In addition, a password for allowing each call-transfer device 40 to receive the telephone call, and a desired telephone call which the call-transfer devices 40 are allowed to receive. The information of each call-transfer device 40 includes a name, an IP (Internet Protocol) address, a location, and a permission time period for allowing receipt of the telephone call.

The transfer-device selecting module 130 responds to the call request from the caller device 20, and selects one or more call-transfer devices 40 which are allowed to receive the telephone call transferred from the callee device 30 according to the transfer information. The transfer-device selecting module 130 further informs the transfer module 140 of the selected call-transfer devices 40 and the password for allowing the call-transfer devices 40 to receive the telephone call.

The transfer module 140 responds to the information from the transfer-device selecting module 130 and transmits a transfer request to the communication network 10 via the communication unit 120. The transfer request includes the selected call-transfer devices 40 and the password for allowing the call-transfer devices 40 to receive the telephone call. The communication network 10 responds to the transfer request and transfers the telephone call to the selected call-transfer devices 40. As a result, the telephone call can be transferred to the intended call-transfer devices 40.

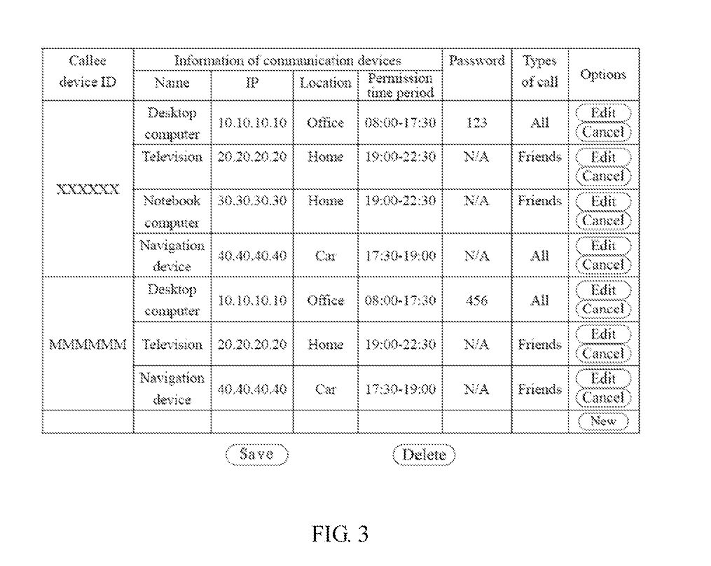

The transfer-interface building module 150 builds a visual transfer-interface 300 (see FIG. 3) for guiding the user to edit the transfer information. FIG. 3 shows that the transfer-interface 300 includes a background, a transfer-information list, a cursor, and a number of options for building the transfer information.

The transfer-information managing module 160 responds to manual input to allow the user to edit the transfer information, for example, add, or delete the transfer information. FIG. 3 shows that to set intended call-transfer devices 40 for a callee device 30 having ID XXXXXX, the cursor is first moved to implement a new-add menu or option. The transfer-interface building module 150 builds a void transfer information list allowing the user to set one or more intended call-transfer devices 40 corresponding to the callee device 30 having ID XXXXXX. Thus, the user can set the permission time period, the password and the predetermined call allowing the set call-transfer devices 40 to receive the telephone call. FIG. 1 shows that the available call-transfer devices include a desktop computer 401 located at, say, the office, a television (TV) 402 and a notebook computer 403 located at home, and a navigation device 404 in the car. Generally, the user will be in the office between 08:00-17:30, and will be in the car to after leaving the office between 17:30-19:00, and will watch TV 402 or use the notebook computer 403 during 19:00˜22:30. Thus, the permission time period of the desktop computer 401 is set to be between 08:00-17:30, the permission time period of the navigation device 404 is set to be between 17:30-19:00, and the permission time period of the TV 402 and the notebook computer 403 is set to be between 19:00-22:30. As a result, the user can flexibly schedule the permission time period of the call-transfer devices 40.

Furthermore, in a certain occasion, for example, in a common office, a password is assigned to the call-transfer device (desktop computer 401), to authenticate the person when he or she receives the telephone call and to prevent another person from receiving the telephone call transferred form the callee device 30. Each call-transfer device 40 can also be assigned to receive a desired telephone calls. For example, the TV 402 and the notebook computer 403 are assigned to receive telephone calls from family and friends during the permission time period, to prevent the user from being interrupted at work.

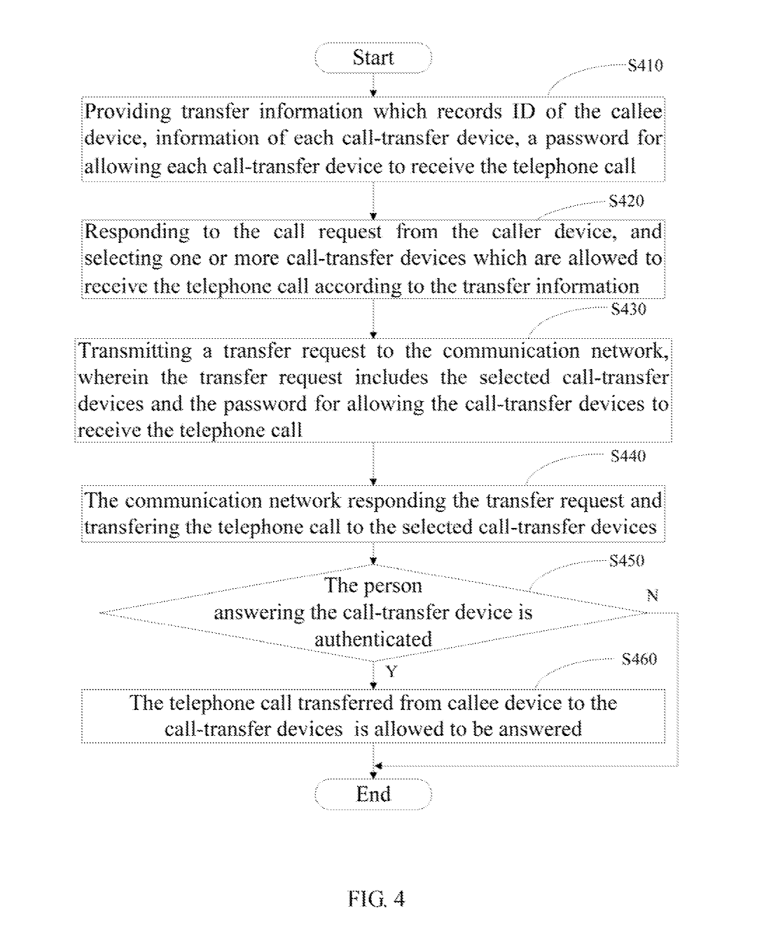

FIG. 4 shows an embodiment of a flowchart of a method for transferring a telephone call. The method is applied to the communication system 100. The method includes the following steps:

In step S410, providing transfer information. The transfer information records at least one ID of the callee device 30, information of each call-transfer device 40 which is allowed to receive the telephone call transferred from the callee device 30. In addition, a password for allowing each call-transfer device 40 to receive the telephone call, and a desired call which the call-transfer devices 40 are allowed to receive. The information of each call-transfer device 40 includes a name, an IP (Internet Protocol) address, a location, and a permission time period for allowing receipt of the telephone call.

In step S420, the callee device 30 responds to the call request from the caller device 20, and selects one or more call-transfer devices 40, which are allowed to receive the telephone call transferred from the callee device 30 according to the transfer information.

In step S430, the callee device 30 transmits a transfer request to the communication network 10 via the communication unit 120. The transfer request includes the selected call-transfer devices 40 and the password for allowing the call-transfer devices 40 to receive the telephone call.

In step S440, the communication network 10 responds to the transfer request and transfers the telephone call to the selected call-transfer devices 40.

In step S450, the communication network 10 further determines whether the person answering the call-transfer device 40 is authenticated. When the person answering the call-transfer device 40 is not authenticated, the procedure ends. When the person answering the call-transfer device 40 is authenticated, the procedure goes to step S460.

In step S460, the telephone call transferred from callee device 30 to the call-transfer devices 40 is allowed to be answered.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A communication device communicating with a caller device and at least one call-transfer device, comprising:
a communication unit for receiving a call request from a caller device;
a storage unit storing a plurality of modules of a transfer system and transfer information, wherein the transfer information comprises at least one ID (Identify) of the communication device, an information of a call-transfer device which is allowed to receive the telephone call transferred from the communication device; and
a processing unit to execute the plurality of modules of the transfer system to perform operations of transferring a call, the operations comprising:
responding to a call request from the caller device and selecting at least one call-transfer device according to the transfer information; and
transferring the call to the selected call-transfer device.

2. The communication device as described in claim 1, wherein the information of a call-transfer device comprises at least the IP (Internet Protocol) address and a permission time period for allowing the call-transfer device to receive the call.

3. The communication device as described in claim 2, wherein the information of a call-transfer device further comprises a name of the call-transfer device and a location of the call-transfer device.

4. The communication device as described in claim 1, wherein the transfer-information further comprises a password for allowing the call-transfer device to receive the telephone call.

5. The device as described in claim 4, wherein the operations further comprises:
building a visual transfer-interface for guiding the user to edit the transfer information; and
editing the transfer information in response to user's input.

6. A method for transfer a call from a callee device to a call-transfer device, comprising:
the callee device providing transfer information, wherein the transfer information records at least one ID (Identify) of the callee device, an information of at least one call-transfer device which is allowed to receipt the call transferred from the callee device;
responding to a call request from a caller device and selecting at least one call-transfer device according to the transfer information; and
transferring the call to the selected call-transfer device.

7. The method as described in claim 6, wherein the information of a call-transfer device comprises at least the IP (Internet Protocol) address and a permission time period for allowing the call-transfer device to receive the call.

8. The method as described in claim 7, wherein the information of a call-transfer device further comprises a name of the call-transfer device and a location of the call-transfer device.

9. The method as described in claim 6, wherein the transfer-information further comprises a password for allowing the call-transfer device to receive the telephone call.

10. The method as described in claim 6, further comprising:
building a visual transfer-interface for guiding the user to edit the transfer information; and
editing the transfer information in response to user's input.

11. A non-transitory computer-readable storage medium encoded with a computer program, the program comprising instructions that when executed by one or more computers cause the one or more computers to perform operations of transferring a call of a communication device, the operations comprising:
the callee device providing a transfer information, wherein the transfer information records at least one ID (Identify) of the callee device, an information of at least one call-transfer device which is allowed to receipt the call transferred from the callee device;
responding to a call request from a caller device and selecting at least one call-transfer device according to the transfer information; and
transferring the call to the selected call-transfer device.

12. The non-transitory storage medium as described in claim 11, wherein the information of a call-transfer device comprises at least the IP (Internet Protocol) address and a permission time period for allowing the call-transfer device to receive the call.

13. The non-transitory storage medium as described in claim 12, wherein the information of a call-transfer device further comprises a name of the call-transfer device and a location of the call-transfer device.

14. The non-transitory storage medium as described in claim 11, wherein the transfer-information further comprises a password for allowing the call-transfer device to receive the telephone call.

15. The non-transitory storage medium as described in claim 11, wherein the operations further comprises:
building a visual transfer-interface for guiding the user to edit the transfer information; and
editing the transfer information in response to user's input.
